(19) United States
(12) Patent Application Publication
(10) Pub. No.: US 2003/0105653 A1
(43) Pub. Date: Jun. 5, 2003

(54) Method, software product, system and apparatus for managing multiple channels of travel services

(76) Inventors: Vajid Husain Jafri, Redwood Shores, CA (US); Christopher John Hanson, Palo Alto, CA (US); Vipin Kumar, Union City, CA (US); Sajid Husain Jafri, Foster City, CA (US)

Correspondence Address: ELLSWORTH R. ROSTON, ESQ., FULWIDER, PATTON, LEE & UTECHT, LLP, HOWARD HUGHES CENTER, 6060 CENTER DRIVE 10TH FLOOR, LOS ANGELES, CA, 90045, US

(21) Appl. No.: 10/010,300

(22) Filed: Dec. 5, 2001

(51) Int. Cl. G06F 17/60

(52) U.S. Cl. 705/5

(57) ABSTRACT

A method of presenting offers of travel services is disclosed. The method may include providing a client computer having a human interface, inputting requests for details of travel services, sending requests to a GDS and to a server computer, translating the request into web requests, sending web requests to websites and receiving responses therefrom, and displaying responses from the websites and from the GDS on a single display screen. Software and hardware such as may be used for embodying the method are also disclosed.

### FIELD OF THE INVENTION

This invention relates to services and accounting within the retail and wholesale travel services industries. This invention further relates to a system and a method for gathering, offers of travel services from each of multiple travel service suppliers and their agents.

### BACKGROUND

The commercial sector of the Web has been extensively used for direct sales of travel services At the consumer or end-user level, systems and methods for conducting e-commerce typically involve a Computer running a Web browser for accessing Web pages from remote servers via the one and only, well known, Internet.

Computerized travel booking services, especially for air travel have become more complex with the rise in popularity of the Internet. Not only are there many more sources of services but terms and conditions are increasingly complex. A need to manage the various complexities on a single client computer exists. Sales and ancillary sales support activity (such as ticketing) within the travel industry is typified or dominated by an airline component. Thus the airline component services of the travel industry is paradigmatically used and envisioned in accompanying diagrams. A small number of online services provide a large proportion of air travel fares quotation and ordering for air travel booked by travel agents for clients. There are four such online services, they are known by their trade names, Sabre®, Worldspan®, Galileo® and Amadeus®. These are collectively and individually known, in the art, as GDS (global distribution system(s)).

An important reason that travel agents use GDS is that they provide familiar bookkeeping arrangements, credit, ticketing, refunds and other terms and conditions. Especially, GDS generate accounting records for computerized billing systems and reports including statistics for clients. Such report keeping is of great importance to business and corporate clients.

However the Internet and the World Wide Web (the Web) have become everyday utilities for many businesses and individuals and often provide cheaper tickets than are available through GDS's. Under price performance pressure travel agents scan the world wide web for better prices and then purchase tickets over the Internet. The travel agent must then typically enter the purchase into a GDS in order to generate the required accounting records. Often too a service charge (profit margin) must be charged separately rather than a preferred method of bundling or commissions from supplier. Another problem is that Internet sales can often have complex and unfamiliar terms and conditions with the risk that the agent may purchase a non-refundable fares only to later notice a restriction that makes the fare useless to the client. Since the terms are not presented in a standard way they are open to misinterpretation, also the agent may need authorization to advance credit (usually credit card credit) for the purchase. This can result in a dilemma for the business owner as to how much authority to spend money should be given to the agent since each situation is unique. Thus the Internet is not as travel agent friendly as the GDS, however sometimes travel agents must use the Internet to access websites or lose business. Websites are well known in the art.

### SUMMARY OF THE INVENTION

According to a first aspect of the invention, a method of presenting offers of travel services is disclosed. The method may include providing a client computer having a human interface, inputting requests for details of travel services, sending requests to a GDS and to a server computer, translating the request into web requests, sending web requests to websites and receiving responses therefrom, and displaying responses from the websites and from the GDS on a single display screen.

According to a further aspect of the invention, software is provided to implement the method of the first aspect.

According to a still further aspect of the invention, computers are provided to implement the method of the first aspect.

These and other features and advantages of the invention are set forth in part in the description which follows and in part will become apparent to those having ordinary skill in the art upon examination of the following or may be learned from practice of the invention. The advantages of the invention may be realized and attained as particularly pointed out in the appended claims. The embodiments described should be viewed as exemplary and enabling and disclosing best known mode rather than limiting as to the bounds of the invention.

### BRIEF DESCRIPTION OF DRAWINGS

FIG. 1 shows a high level depiction of one embodiment of the invention.

FIG. 2 shows a high level depiction of a travel agency client computer network according to an embodiment of the invention.

FIG. 3 schematically represents a client computer used in an embodiment of the invention.

FIG. 4 schematically represents a server computer such as may be used to implement embodiments of the invention.

FIG. 5 shows a client computer display screen 500 layout such as may be used in one embodiment of the invention.

FIG. 6 shows a flow diagram of reservation functions according to an embodiment of the invention.

FIG. 7 shows a flow diagram of accounting functions according to an embodiment of the invention.

### DETAILED DESCRIPTION

Consumer computer systems and methods are well known in the relevant arts.

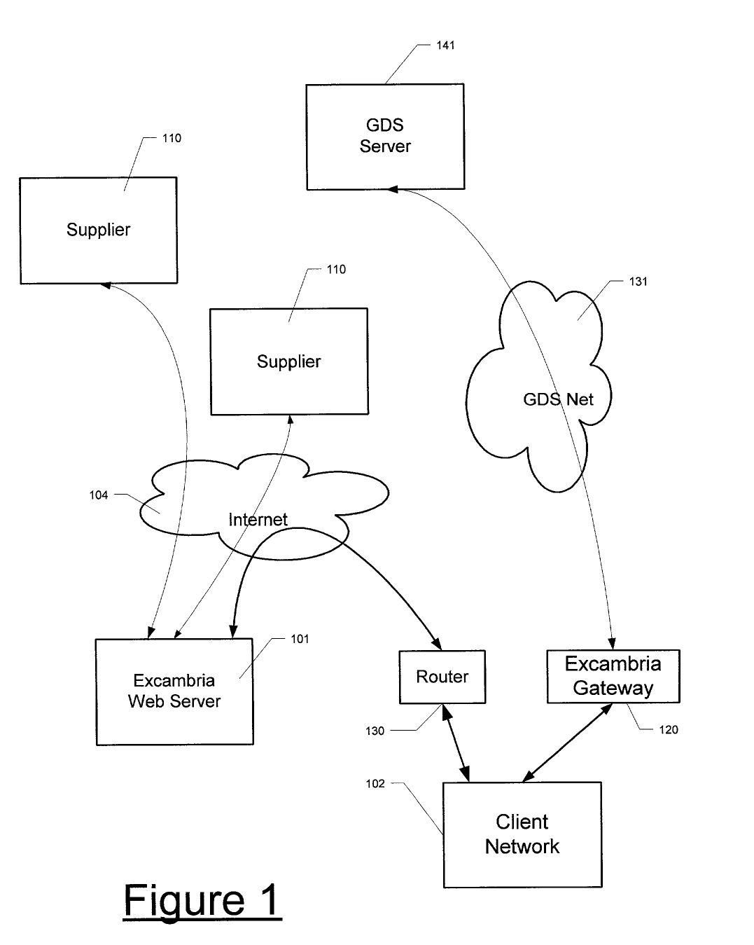

A high level depiction of one embodiment of this invention is shown in FIG. 1. Box 101, relates to one or more distributed processing servers which are well understood in the art. One particular such server that has been used to embody the invention is the Excambria(TM) Web Server 101 which is used as an example herein. The figure depicts a travel Agency client computer network 102 which may contain computer workstations (not shown in FIG. 1) that may connect through a router 130 and the Internet 104 to Excambria web server 101. The well known Internet Protocol (IP) is used to communicate over the Internet which is also well known in the art. Excambria server 101 in turn connects via Internet 104 to multiple supplier server computers 110 (two shown but typically many available). Supplier computers may typically operate as e-commerce websites, exchanging requests and responses by means of Internet oriented protocols such as FTP, HTTP, HTML, XML and/or many others.

Travel Agency client computer network 102 also connects through a Gateway 120 through a proprietary GDS telecommunication networks 131 to one of the several GDS 141 that may be available and which are typically based on mainframe computers. Presently there are four GDS in total and they are well known in the art.

Again referring to FIG. 1, examples of entities that may constitute server machines (box 101) are remote servers, auction servers, transaction servers, inventory systems, supplier managed systems, etc . . .

Parts of the invention may incorporate (have parts that are implemented on) one or more of these example entities. The invention may also incorporate entities that are not listed herein. These entities cooperate with each other in gathering, transmitting, requesting, manipulating, etc . . . travel related service information. The Internet Protocol (IP) is used for communication over the Internet (box 104) as is well understood in the art.

These and other features and advantages may be accomplished by the provision of alternative topologies of computer systems incorporating client computer(s), Internet server computers and GDS.

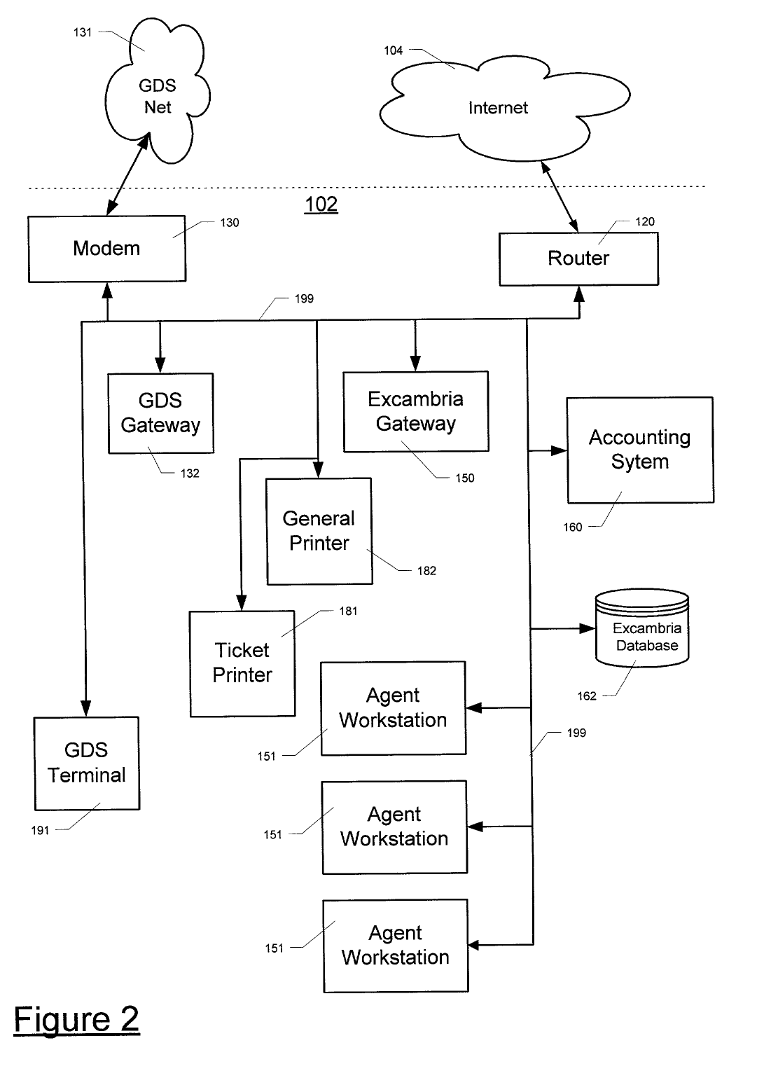

FIG. 2 shows a high level depiction of a travel agency client computer network 102 according to an embodiment of the invention. The exemplary travel agency client computer network 102 may function as depicted in FIG. 1. Still referring to FIG. 2, the travel agency client computer network 102 connects to Internet 104 and GDS proprietary network 131. Gateway 130 connects GDS network 131 and Router 120 connects Internet 104. GDS Net 131 provides communication to and from a GDS (not shown in FIG. 2) and Internet 104 provides communication to and from an Excambria server (also not shown in FIG. 2).

Various intelligent devices within the travel agency client computer network 102 interconnect, for example, by means of a LAN (local area network) 199 which may be Ethernet, Token Ring or other LAN technology. Optional GDS terminal 191 may be a retained or “legacy” device that may be used by travel agents to access GDS, for example, outside the context of the invention. GDS Gateway 132 operates on behalf of GDS terminal 191 to forward requests and responses to GDS network 131 via modem 130.

One or more Agent workstations 151 are provided for individual use by travel agents, typically such workstations may be implemented as software and hardware based upon the ubiquitous PC (Personal Computer). Agent workstations 151 communicate via Excambria gateway 150, LAN 199, Router 120 and Internet 104 with Excambria web server computer (not shown in FIG. 2). Excambria gateway 150 operates on behalf of agent workstations 151 to forward requests and responses to GDS network 131 via modem 130. The accounting system computer 160 may receive messages from many sources and maintains accounting records on an accounting database (not shown). The agent workstations 151 are typically client computers (PC) that implement Excambria client programs. Agent workstations 151 may be referred to, for convenience, as communicating with a GDS, but the Excambria gateway 150 receives requests and responses and forwards them to GDS from agent workstation or vice versa.

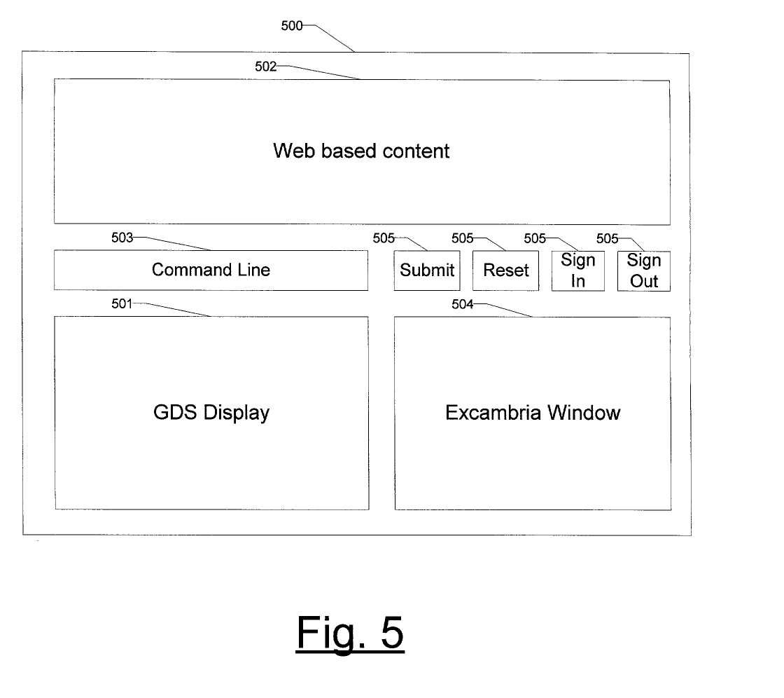

FIG. 5 shows an exemplary client computer display screen 500 layout such as may be used in one embodiment of the invention. The display screen 500 is divided into area or windows 501, 502, 503, 504 and perhaps others. In one embodiment the large area GDS Display window 501 provides a character-oriented scrolling window as may be required by GDS for the traditional human/computer interface thereto. Thus, a terminal emulation of a real GDS terminal optionally including features such as synchronous protocol may be performed using display window 501 and a client computer keyboard. The itinerary may be captured by filtering and interpreting a GDS formatted inquiry using command line 503 in the client computer or in an Excambria gateway or alternatively the itinerary may be entered directly using the human interface (e.g. keyboard) into command line 503. Various command “buttons” 505 for functions may be provided in accordance with the well known computer windows human interface. Window 502 may be used to display information such as inventory and pricing for itineraries located by an Excambria web server (and other web based content) as is discussed below.

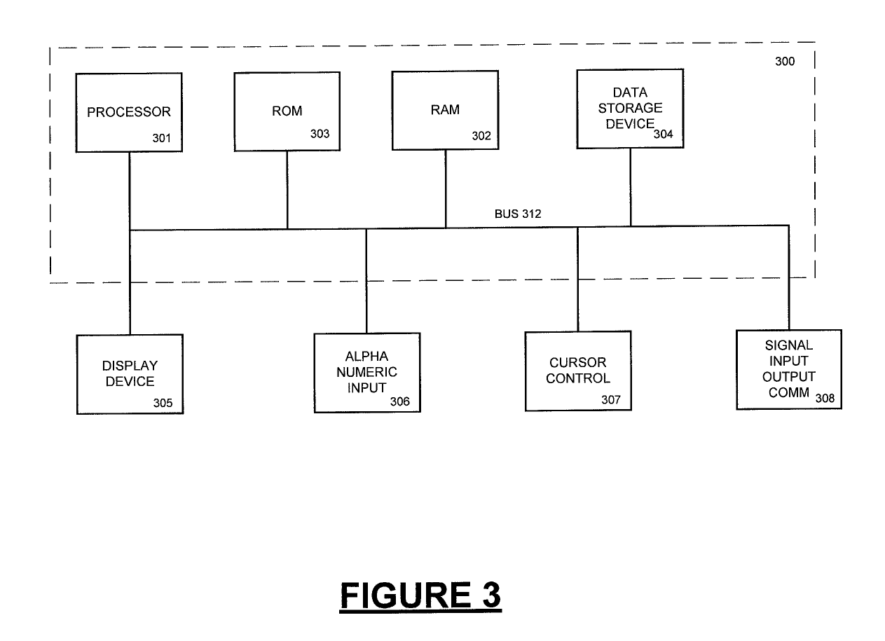

Reference is made to FIG. 3 illustrating a block diagram of a typical client computer system 300 which maybe implemented or practiced by using the present invention. Such a client computer system may serve as the client computer system 102 of FIG. 1. Referring again to FIG. 3, client computer system 300 is connected to the Internet (not shown expressly but typically via data communications port 308 sometimes known as an I/O interface). It is to be appreciated that client computer system 300 is exemplary only and that the present invention can operate within a number of different computer systems including general purpose computer systems, embedded computer systems, and others. In the following discussions of the present invention, certain processes and steps that are realized as a series of instructs (e.g., software program) that reside within computer readable memory units of system 300 and executed by processors of system 300.

In general, client computer system 300 used by the present invention comprises address/data bus 312 for conveying information and instructions, central processor (CPU) 301 coupled with bus 312 for processing information and instructions, a random access memory (RAM) 302 for storing digital information and instructions, a read only memory (ROM) 303 for storing information and instructions of a more permanent nature. In addition, client computer system 300 may also include a data storage device 304 (e.g., a magnetic, optical, floppy, tape drive, etc . . . ) For storing vast amounts of data, and an I/O interface 308 for interfacing with peripheral devices (e.g., computer network, modem, etc . . . ). More particularly, the memories (e.g., RAM 302, ROM 303, and data storage device 304) of client computer 300 store the instruction codes in accordance with the present invention. A person of ordinary skill in the art will understand that the memories may also contain additional information such as applications programs, network communication programs (e.g., TCP/IP protocol), operating system software, data, etc . . .

Moreover, computer system 300 may include a display device 305 for displaying information to a computer user, an alphanumeric input device 306 (e.g., keyboard), and a cursor control device 307 (e.g., mouse, track-ball, light-pen, etc . . . ) for communicating user input information and command selections. This human oriented input and output features may be collectively used as the human interface.

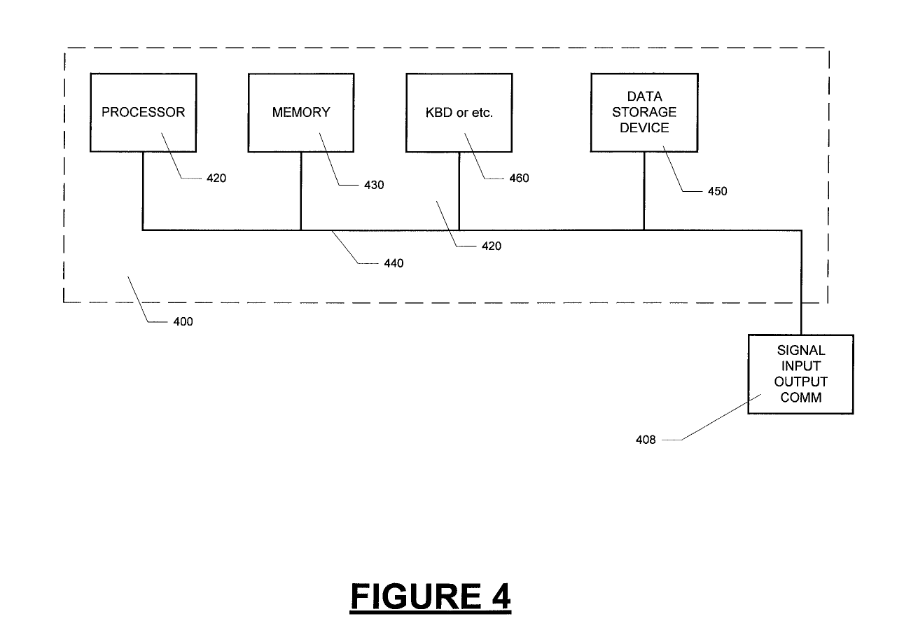

Referring to FIG. 4, server computer 400 comprises central processing unit CPU 420, memory 430, and communications adapter 408 which are connected together by system bus 440. Such a server computer system may serve as the Excambria server computer system 101 of FIG. 1. Memory 430 stores software. It will be understood by a person of ordinary skill in the art that server computer 400 can also include other elements not shown in FIG. 4 such as disk drives 450, keyboard 460, etc . . . A person of ordinary skill in the art will understand that memory 430 may also contain additional information such as applications programs, network communication programs (e.g., TCP/IP protocol stack), operating system software, data, etc . . . Client computer 300 and server computer 400 are linked together by a network, typically the Internet. Furthermore, a person of ordinary skill in the art will understand that the computer systems 300 and 400 may contain more or less than what is shown in FIGS. 3 and 4.

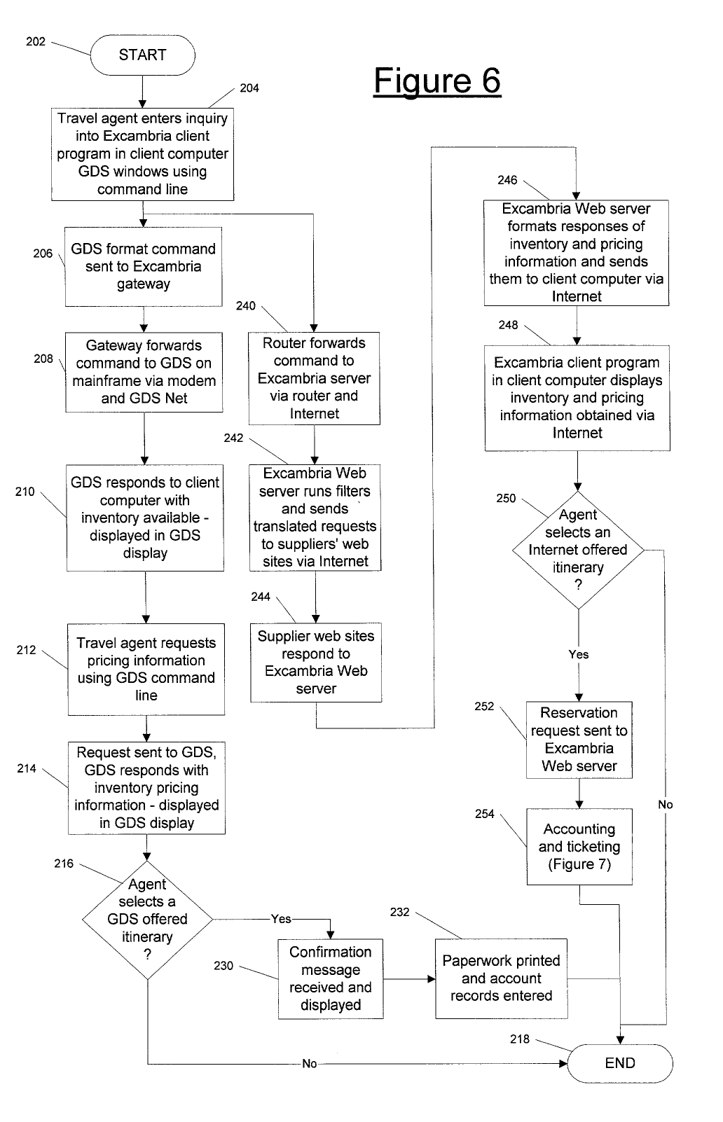

Reference is now made to FIG. 6 illustrating a flow diagram of a reservation method according to an embodiment of the invention. The figure effectively shows the computer implemented acts to carry out part of the embodiment of the present invention. In general, the acts in FIG. 6 are designed to implement travel agent service mechanisms. The acts in FIG. 6 are carried out when processors 301, and 420 (FIGS. 3 and 4) execute the instruction codes stored in the memory of computer systems 300 and 400 (FIGS. 3 and 4). Websites and GDS, as are well known in the art, may also perform some of the necessary functions. It is to be appreciated that the acts described herein are illustrative only and other sequences of steps could be used within the general scope of the invention.

Still referring to FIG. 6, In box 202, the method is stated. In box 204, the travel agent enters an inquiry, such as for flight availability and/or pricing. The travel agent enters the inquiry into Excambria client program in client computer command line window using a command line format. A traditional concise GDS format is used, for example command such as “ALAXSFO22NOV” might be used to inquire as to the availability of airline ticket for travel from Los Angeles to San Francisco on 22^{nd} November next. The client computer software may express the inquiry as a command upon the screen. Then in box 206, the client computer software forwards the GDS format command to Excambria gateway. The gateway may be a separate computer (as shown in FIG. 2) or it could be a physical or logical subsystem of the client computer itself. In box 208 the Gateway forwards command to GDS on mainframe via modem and GDS Net. In box 210 the GDS responds to client computer (typically via the Gateway) with inventory available which displayed in the GDS display window. In box 212 the travel agent requests pricing information using GDS command line format. In box 214, the request is sent to GDS, GDS responds with inventory pricing information which is displayed in GDS display window of Excambria client program in client computer. In box 216 the travel agent decides whether to select a GDS offered itinerary. If not the GDS based part of the method ends in box 218. Otherwise, in box 230, the GDS itinerary is selected and a confirmation message received and displayed by old GDS based procedures. In box 232 paperwork printed and account records entered as for old GDS systems.

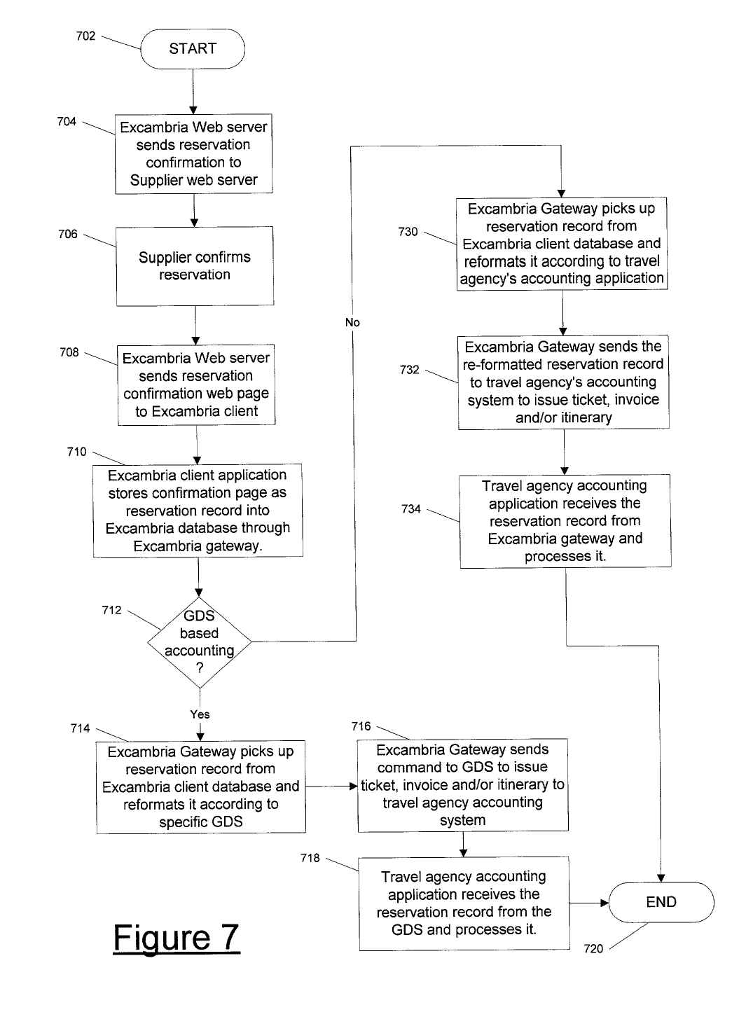

Meanwhile, in box 240, the router forwards command to Excambria web server via router and Internet. In box 242, the Excambria Web server runs filters and sends translated requests to suppliers' web sites via the Internet. In box 244, the suppliers' web sites respond to the Excambria Web server. The, in box 246, the Excambria Web server formats responses of inventory and pricing information and sends them to client computer via Internet. In box 248, the Excambria client program in client computer displays inventory and pricing information obtained via Internet. Then in box 250, the travel agents decides whether to select an Internet offered itinerary. If not then the web based part of the method ends in box 218. Otherwise, in box 252, a reservation request is sent to Excambria Web server and in box 254, accounting and ticketing may take place as described below in connection with FIG. 7.

It should be appreciated that, as may be required, the Excambria web server may translate commands into various forms as may be responded to by the web site of travel services suppliers such as airlines, consolidators, tours operators or the like. Thus, the Excambria server maintains a dialog with various travel sites sending web formatted commands according to the temporal needs of the many client computers at various locations. In the example given, a request for travel information between Los Angeles and San Francisco would not generate a web site inquiry to the website of British Airways since they do not offer US domestic travel. On the other hand inquiries may be sent to the web sites of the dozen or so airlines that do offer LAX-SFO ticketing. If the agent is dissatisfied with all the itineraries offered—or if indeed there are no offers for reason of no availability the agent may terminate the procedure and start again with, for example, a revised travel date after possible consultation with the prospective traveler. In addition to the functions described in connection with FIG. 6, embodiments of the invention may provide for capturing accounting data for travel services booked via the Excambria web server. One expanded example of the functions of box 254 according to one embodiment of the invention is shown in FIG. 7. FIG. 7 shows a flow diagram of accounting functions according to an embodiment of the invention. In box 702 the method starts. In box 704, the Excambria Web server sends a reservation confirmation to a supplier web server via the Internet. In box 706, the supplier confirms the reservation. In box 708, the Excambria Web server sends reservation confirmation web page to Excambria client program in client computer. In box 710, the Excambria client application program stores the confirmation page as a reservation record into an Excambria database via the Excambria gateway. In box 712 a decision is made as to whether GDS based accounting is to be used.

If so, in box 714, the Excambria Gateway picks up reservation record from Excambria client database and reformats it according to specific GDS. Then in box 716, the Excambria Gateway sends a command to GDS to issue ticket, invoice and/or itinerary to travel agency accounting system. In box 718, the travel agency accounting application receives the reservation record from the GDS and processes it and the method ends in box 720.

If GDS based accounting is not to be used, then in box 730 the Excambria Gateway picks up the reservation record from the Excambria client database and reformats it according to travel agency's accounting application. In box 732, the Excambria Gateway sends the re-formatted reservation record to the travel agency's accounting system to issue ticket, invoice and/or itinerary. In box 734, the travel agency accounting application receives the reservation record from Excambria gateway and processes it and the method ends.

Many other embodiments of accounting functions are feasible within the general scope of the invention. The foregoing embodiments are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method of presenting offers of travel services comprising:
a. providing a client computer having a human interface;
b. inputting via the human interface, a request for details of travel services, the request being in a format intelligible to a GDS;
c. sending a first copy of the request to the GDS;
d. sending, through Internet, a second copy of the request to a server computer;
e. receiving, from the GDS, a first details of travel services;
f. receiving, via Internet, from the server computer, a second details of travel services, the second details of travel services having been received by the server computer in response to at least one supplier response received by the server computer in response to a supplier request, from the server computer, to a supplier, wherein the supplier request is composed responsive to a data content of the request for services; and
g. outputting, via the human interface, a representation of the first and the second details of travel services

2. The method of claim 1 wherein:
the supplier response is a web response received from a supplier web site and the supplier request is a web request send via Internet.

3. The method of claim 1 further comprising:
the act of emulating a GDS terminal.

4. A method of generating an accounting record comprising the acts of:
receiving in a client application program a reservation confirmation from Internet;
reformatting the reservation confirmation according to a GDS (global distribution system) to create a reformatted reservation record;
sending the reformatted reservation record to the GDS and
receiving by an accounting application program, an accounting record sent by the GDS in response to receiving the reformatted reservation record.

5. A method of generating an accounting record comprising the acts of:
receiving in a client workstation application program a reservation confirmation from Internet;
reformatting, in a gateway, the reservation confirmation according to an accounting application program to create a reformatted reservation record;
sending the reformatted reservation record to an accounting in an application system computer and
receiving by the accounting application program, the reformatted reservation record sent by the gateway.

6. An article of manufacture comprising:
at least one computer readable medium having computer readable program code embodied jointly or severally thereon for causing a plurality of computers to perform the acts of:
a. providing a human interface;
b. inputting via the human interface, a request for details of travel services, the request being in a format intelligible to a GDS;
c. sending a first copy of the request to the GDS;
d. sending, through Internet, a second copy of the request to a server computer;
e. receiving, from the GDS, a first details of travel services;
f. receiving, via Internet, from the server computer, a second details of travel services, the second details of travel services having been received by the server computer in response to at least one web response received by the server computer in response to a web request, from the server computer, to a web site, wherein the web request is composed responsive to a data content of the request for services; and
g. outputting, via the human interface, a representation of the first and the second details of travel services.

7. A computer system for presenting travel industry services comprising:
a client computer; and
a server computer communicating with the client computer using Internet;
wherein the server computer and the client computer cooperatively exchange data and execute instructions for:
a. providing a human interface;
b. inputting via the human interface, a request for details of travel services, the request being in a format intelligible to a GDS;
c. sending a first copy of the request to the GDS;
d. sending, through Internet, a second copy of the request to a server computer;
e. receiving, from the GDS, a first details of travel services;
f. receiving, via Internet, from the server computer, a second details of travel services, the second details of travel services having been received by the server computer in response to at least one web response received by the server computer in response to a web request, from the server computer, to a web site, wherein the web request is composed responsive to a data content of the request for services; and
g. outputting, via the human interface, a representation of the first and the second details of travel services.
